(19) United States
(12) Patent Application Publication
(10) Pub. No.: US 2014/0224882 A1
(43) Pub. Date: Aug. 14, 2014

(54) Flexible Smart Card Transponder

(71) Applicants: Douglas R. Hackler, SR., Boise, ID (US); Dale G. Wilson, Kuna, ID (US)

(72) Inventors: Douglas R. Hackler, SR., Boise, ID (US); Dale G. Wilson, Kuna, ID (US)

(21) Appl. No.: 14/181,539

(22) Filed: Feb. 14, 2014

Related U.S. Application Data
(60) Provisional application No. 61/764,810, filed on Feb. 14, 2013.

(30) Foreign Application Priority Data
Feb. 4, 2014 (US) PCT/US14/14740

(51) Int. Cl. G06K 19/077

(52) U.S. Cl. CPC G06K 19/0779
USPC 235/488; 235/492

(57) ABSTRACT

This smart card transponder is made extremely flexible by being ultrathin. Its thickness of only 0.25 mm is achieved by using all ultrathin flexible substrates. A Semiconductor-on-Polymer (SOP) process creates flexible integrated circuit (IC) components which are applied to a flexible antenna substrate. With suitable selection of materials, no additional substrates are required. The antenna substrate may be a thin PVC or even paper. The antenna is printed directly onto the substrate using conductive ink. Passive components such as resistors, capacitors, inductors and delay lines are also formed from conductive ink as appropriate to the circuit being implemented. Interconnections between components are created in a similar process. The ultrathin SOP ICs require no bonding wires since their contact pads are readily accessible for attachment to the interconnects through conductive epoxy. Extreme flexibility of all componentry enhances reliability while enabling inclusion of larger, more complex ICs.

### CROSS-REFERENCES TO RELATED APPLICATIONS

This application claims benefit of U.S. Provisional Application No. 61/764,810 filed Feb. 14, 2013, entitled “Flexible Smart Card Transponder”, which is incorporated here by reference in its entirety.

This application is related to International Application No. PCT/US14/14740 filed Feb. 4, 2014, entitled “Photonic Data Transfer Assembly”, which application also claims benefit of U.S. Provisional Application No. 61/764,810.

### FIELD OF THE INVENTION

The present invention relates generally to a smart card. In particular, the described devices and methods pertain to a transponder in a flexible smart card format.

### BACKGROUND OF THE INVENTION

In general, a transponder is a device that emits an identifying signal in response to reception of an interrogating signal. Transponders, as used in applications such as smart cards, function as traditional transponders with contactless capability. They require no battery and are powered and read at short ranges via magnetic fields using electromagnetic induction. The wireless non-contact utilization of radio-frequency electromagnetic fields is also utilized to power logic and memory operations on the card and to transfer data from a card to an object such as a card reader.

A transponder in a smart card format is a type of data storage and/or computing device that is commonly used for contactless or hybrid smart cards. The device is a complex rigid assembly that includes one or more integrated circuit (IC), an antenna with a substrate, connection of the chip's bond pads to the substrate and a molded body to protect the chip. The ICs used in smart card transponders are very limited in die area due to reliability issues associated with the deformation of cards encountered during typical use. Rigid IC's fracture and break when bent. The larger the IC, the greater the failure rate. Transponder assemblies used in smart cards are typically 0.5 mm (500 um) in thickness and are individually inlayed in a complex cavity formed in a card body that is commonly made of PVC. For contactless smart cards the antenna is commonly a coil of copper wire. The antenna is integrated as an additional card inlay in another cavity on the same card and connected to an IC to provide wireless communication and enable RFID (RF Identification) capability. The requirement for a cavity limits the card thickness and increases the cost of manufacturing.

### BRIEF SUMMARY OF THE INVENTION

The flexible smart card transponder is a device that is enabled by the utilization of ultra-thin flexible Semiconductor-on-Polymer (SOP) Integrated Circuits (ICs) that are integrated with a printed RF antenna. The flexible smart card is ultra-thin and can be laminated as a card layer without the use of cavities or cutouts. This reduces the cost of the card material and simplifies card manufacturing. One embodiment of the flexible transponder places the IC and the RF antenna in a flexible hybrid electronic system that is printed on a flexible substrate, including bonding of the IC on the flexible substrate in contact with the RF antenna. The realization of a transponder as a single card layer provides feasibility for contactless smart cards using a variety of low cost card stocks that may include paper. The flexible smart card transponder is ultra-thin, flexible and is not subject to the reliability failures associated with the deformation of conventional rigid transponder assemblies. This important feature eliminates limits on die size for reliability and enables the use of larger ICs and arrays of ICs for large scale memory and processing.

### BRIEF DESCRIPTION OF THE DRAWINGS

The particular features and advantages of the invention will become apparent from the following description taken in conjunction with one or more of the accompanying FIGS. 1-11 of the drawings:

FIG. 1 depicts a generic integrated circuit as an unmounted rigid die;

FIG. 2 illustrates attachment of the die of FIG. 1 to an antenna assembly;

FIG. 3 shows a typical smart card having a cavity for reception of a die and antenna assembly;

FIG. 4 shows the antenna assembly with an attached die mounted in the cavity of the smart card of FIG. 3;

FIG. 5 illustrates sealing of a top cover to FIG. 4 to produce a conventional contactless smart card;

FIG. 6 depicts an unmounted rigid die without and with requisite bonding wires;

FIG. 7 illustrates placement of the rigid die with bonding wires into a cavity in a conventional smart card;

FIG. 8 depicts an unmounted ultra-thin die produced by a SOP process;

FIG. 9 illustrates an adhering of the SOP die to a printed antenna assembly with subsequent lamination and sealing to produce the flexible smart card transponder of FIG. 10; and

FIG. 11 shows an ultra-thin die as depicted in FIG. 8 attached to a printed card body with contacts and vias, without wire bonds or molding, to produce a flexible smart card without a cavity.

The following Reference Numbers may be used in conjunction with one or more of the accompanying FIGS. 1-11 of the drawings:
100 Conventional smart card
110 Rigid IC die
120 Antenna assembly
130 Bonding region
140 Exterior Contact Substrate
150 Conventional rigid smart card foundation
155 Alternative smart card foundation
160 Cavity for die attach
170 Recessed channel for antenna
180 Cover for conventional smart card
200 Flexible smart card
210 Flexible SOP ultra-thin IC die
220 Flexible antenna
240 Exterior Contact Substrate
250 Flexible substrate
260 Via
280 Card Body for flexible smart card

### DETAILED DESCRIPTION OF THE INVENTION

For a device such as a smart card to be useful it must have a means of communicating beyond itself. A radio frequency transponder as used in a smart card format consists of an integrated circuit (IC) computing device and an antenna. Conventional smart cards, described here in FIGS. 1-7, are constructed around, and constrained by, a rigid IC die 110 such as that shown in FIG. 1. A rigid IC is necessarily limited in size by the fact that larger ICs suffer a greater failure rate due to fracturing when they are subjected to bending. The computational and/or data storage capacity of the IC is to some extent limited by its size.

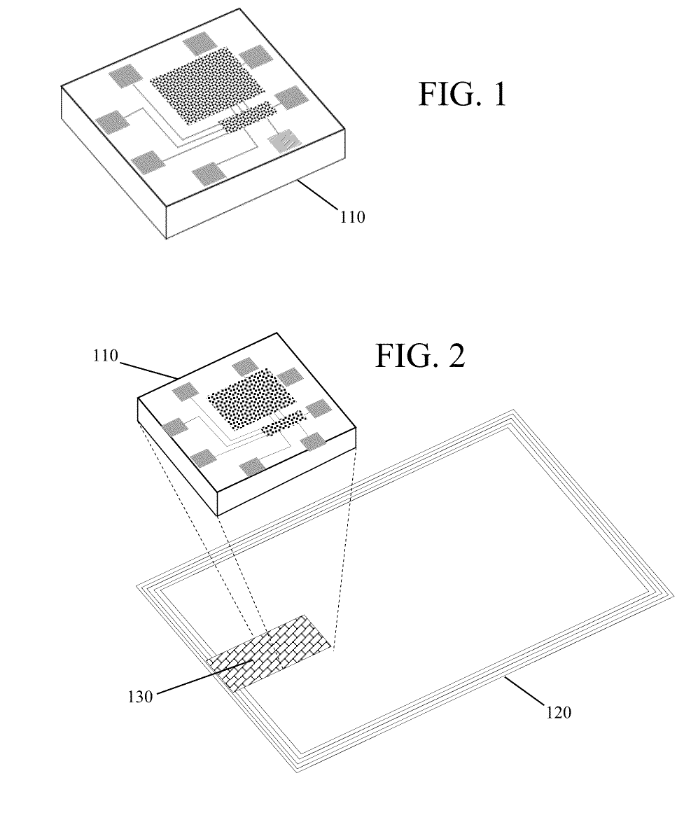

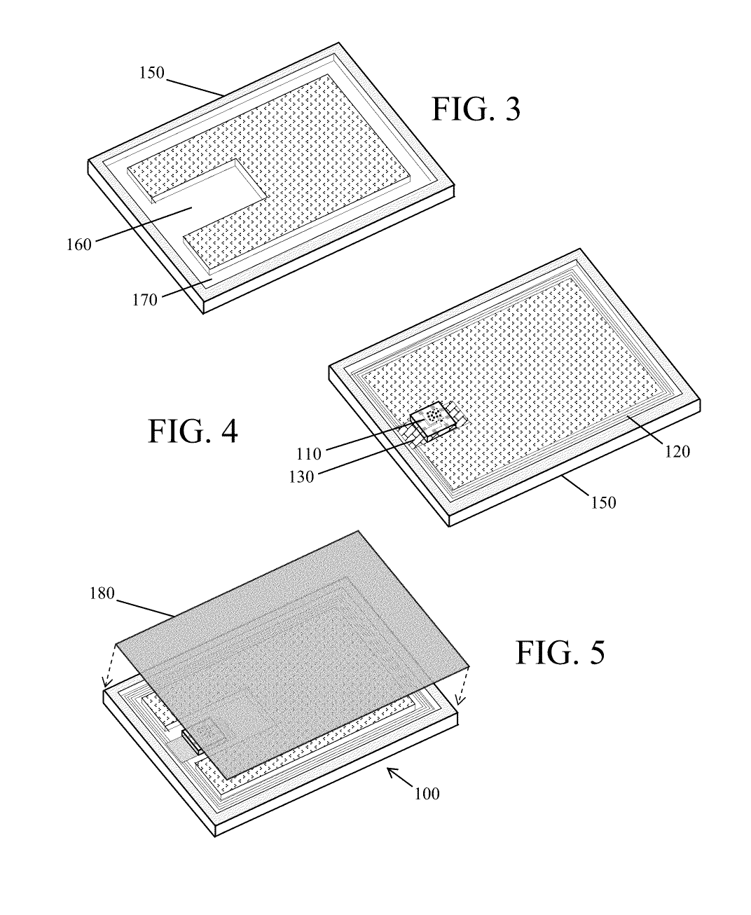

An antenna assembly 120 (FIG. 2) is conventionally formed from a coil of copper wire with some provision for connection with a bonding region 130 to which the IC 110 is attached. The foundation of a conventional rigid smart card 150 is formed, as shown in FIG. 3, with a complex, sometimes multilevel, recessed channel 170 into which the antenna assembly 120 with attached IC 110 is placed (FIG. 4). A typical conventional smart card is formed from PVC and has a thickness of about 0.5 mm. The recesses necessary for mounting of the working components are either molded or milled into this foundation. After the antenna assembly has been inserted into the recess of the rigid smart card foundation and the computation circuitry of the IC has been connected to it (FIG. 4), a top cover 180 is placed over the foundation and sealed to produce the finished product 100 of FIG. 5.

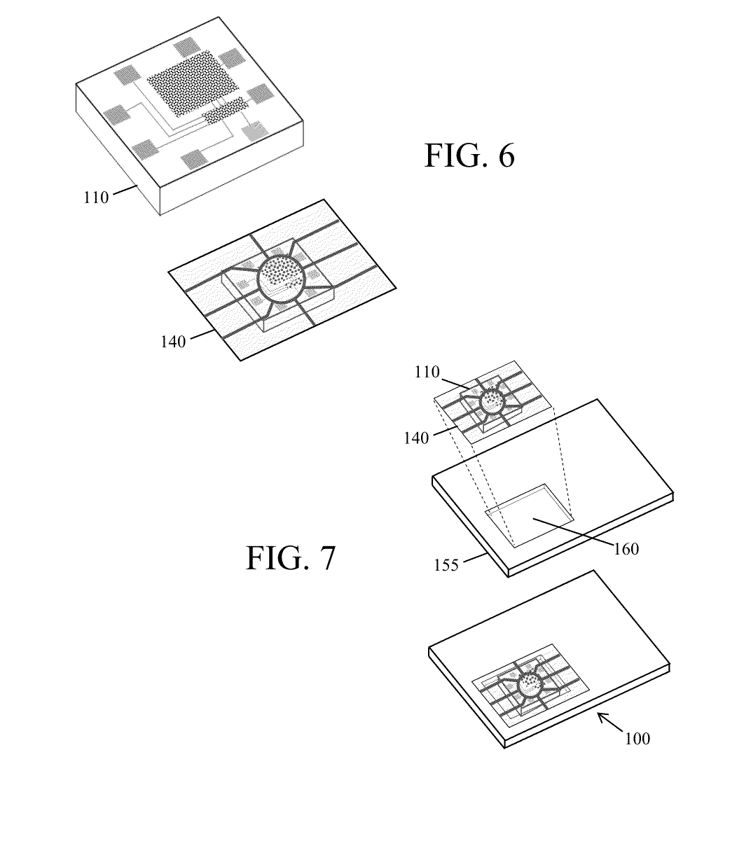

For conventional smart card applications of a more general nature, a rigid IC 110 may be affixed to an exterior contact substrate 140 (FIG. 6). Bonding wires may be used to connect multiple ICs into an array. The exterior contact substrate with mounted circuitry is then placed (FIG. 7) into a cavity 160 in the foundation 155 of an alternate form of a conventional smart card 100.

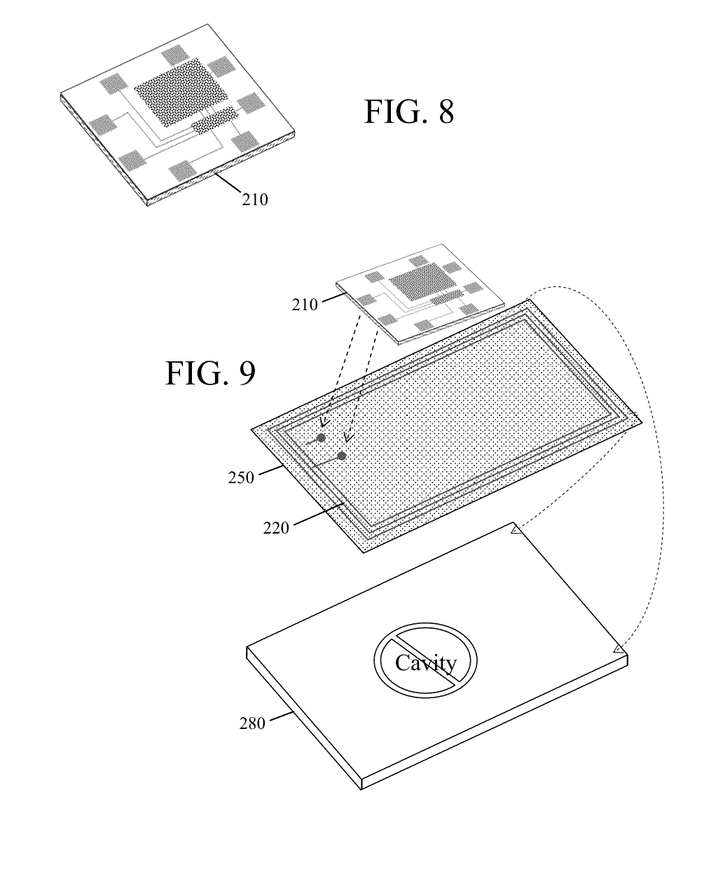

The above described process is considerably simplified by the presently described method to produce a flexible smart card with an overall thickness of less than 0.25 mm. This method is based upon a flexible IC produced by a process such as Semiconductor-on-Polymer (SOP). By virtue of its being thin and flexible, the IC 210 of FIG. 8 may be larger and therefore more capable while also being more reliable than the rigid ICs used in previous smart cards.

The flexible IC 210 does not need to be mounted on a rigid foundation. For the assembly shown in FIG. 9, a variety of flexible substrates 250 may be used, including thin PVC, PET, or even paper; that is, any flexible material that can provide suitable dielectric isolation. The substrate material may be processed in sheet or roll-to-roll form to enable large volume production at low cost. The IC 210 may be placed directly on the substrate 250 with no need for a protective cavity. A flexible hybrid assembly is created by the addition of flexible IC 210 to the flexible substrate 250 with the flexible antenna 220. This assembly is attached to card body 280 to form a smart card.

A flexible antenna 220 may be constructed without wire merely by printing it directly onto the substrate with a conductive ink, forming vias and printed contacts at the same time. The antenna substrate may be a polymer or paper and may easily be laminated onto another substrate for a specific application. Such an antenna is ultra-thin and flexible. It may be single-sided, or double-sided to accommodate printed structures and circuitry on both sides. The antenna substrate may be produced with interconnects or multilayer circuits to accommodate multiple ICs. Furthermore, additional circuitry, such as support logic and memory, may be included on the flexible smart card. For a transponder, the antenna supports both send and receive capability. Low-cost resistors and capacitors that are not available on an IC may be printed directly to the card substrate. There is no need for bonding wires since chip-to-chip interconnects are easily made by conductive inks printed directly onto the substrate and the bonding pads of all thin ICs are connected directly to the flexible substrate 250 by using conductive epoxy to printed contacts and vias. Sealing of the assembly to produce the finished flexible smart card of FIG. 10 is a simple lamination process such as that used for protecting other important papers. It is to be noted, however, that the use of SOP ICs, with their inherently protective polymer coating, allows for the transponder layer to remain as an external card layer without additional lamination.

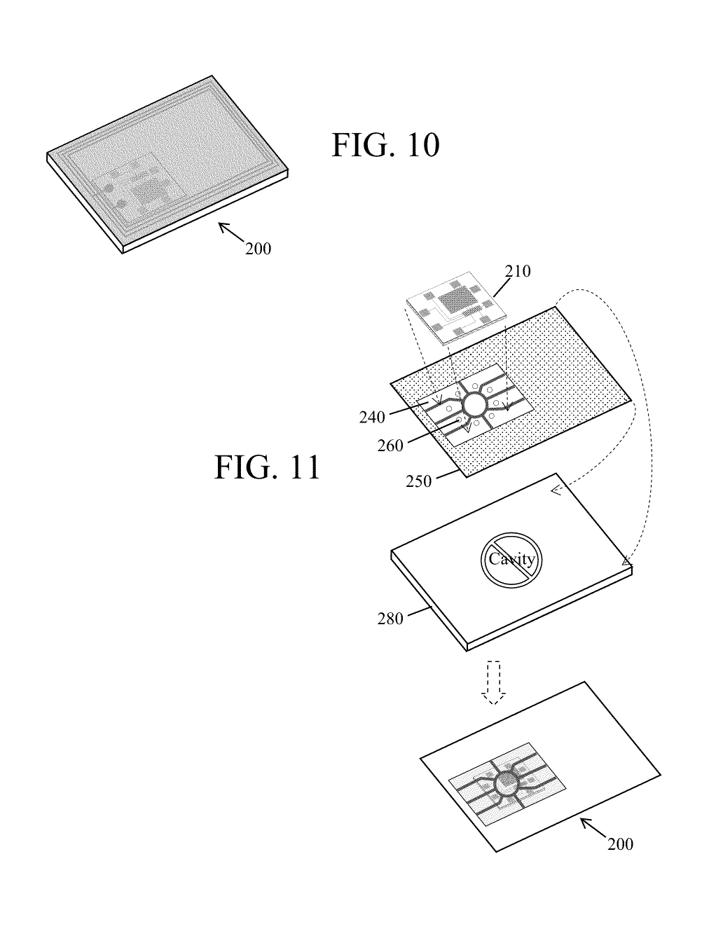

The general case of a flexible IC 210 applied to a flexible substrate by means of an exterior contact substrate 240 is shown in FIG. 11. Here, a flexible substrate 250 is pre-patterned to provide all necessary interconnects, including vias 260. This is generally accomplished by printing with a conductive ink. The ICs used in this method are thin and their bonding pads provide an opening through the polymer of the SOP that readily exposes them for contact. When attached to a thin substrate, the product is effectively planar, enabling direct adhesion between ICs and substrate with no need for a cavity to contain and protect the ICs. The thin IC 210 is simply placed onto an exterior contact substrate 240 for attachment to a flexible substrate 250 with electrical connections being made by a conductive epoxy or similar adhesive. Vias 260 through the flexible substrate 250 enable contact to the back side of the exterior contact substrate 240. An appropriate selection of materials for the contact pads and their mating connections allows them to naturally attach to each other when placed in contact. When an SOP IC is used, its own polymer substrate may advantageously assist in adhesion to the antenna and/or card substrate. The polymer coating of the SOP also provides environmental protection for the IC, during card construction as well as in the end product.

Depending upon the application, the laminated cover of the flexible smart card may be transparent or opaque. A transparent cover enables access to light-sensitive circuitry, including optics, where such access is useful, in which applications the cover may also serve as a filter such as for color or polarization. More commonly, such a smart card will use an opaque cover printed with various logos or other identifying information. In any instance, exterior contacts may be directly written into an outer layer of the card where a contacting option is desired instead of, or in addition to, a contactless card format.

In addition to the transponder described here, the flexible smart card may be used in many other applications. The described technology is also applicable to any flexible label whether for product, packaging or personnel, as a replacement for barcodes and magnetic strips. Other applications include a variety of identification systems such as passports and driver licenses where increased “smart” capability is desired, especially for secure documents where it is desirable to have a considerable capacity for updates.

Though the above process has been described using flexible ICs and flexible substrates, there is nothing described here that precludes application of these techniques to a rigid substrate. If a rigid substrate is used, the polymer of the SOP IC could be replaced by a variety of dielectric materials.

It will be recognized by those skilled in these arts that many variations of the described embodiments are possible. Although Semiconductor-on-Polymer (SOP) has been described here as a means of acquiring thin ICs, other means of producing thin ICs would be useful. Also, though silicon is the most likely substrate for flexible ICs, other single crystalline wafer materials are also feasible candidates for the IC substrate. Additional usable materials include graphene, nanotubes and non-crystalline materials. The foundation substrate may also be selected from a variety of thin and flexible materials, not to be limited by the few described here. The benefits of the described smart card transponder are derived from its thinness and flexibility which simultaneously enable low-cost production, durability and reliability. The realization of a transponder as a single card layer provides feasibility for contactless smart cards using a variety of low cost card stocks that may include paper.

What is claimed is:

1. A flexible transponder comprising:
a flexible substrate;
a flexible microelectronic circuit constructed on the flexible substrate,
wherein the flexible microelectronic circuit is capable of radio frequency operation; and
a flexible antenna coupled to the microelectronic circuit,
wherein the flexible antenna is congruent with or conformable to the flexible substrate, and
wherein the flexible substrate, the flexible microelectronic circuit, and the flexible antenna form a flexible hybrid system.

2. The flexible transponder of claim 1, wherein the flexible microelectronic circuit is produced by a Semiconductor-On-Polymer (SOP) process.

3. The flexible transponder of claim 1, wherein the flexible transponder is capable of continuous operation during flexure or other deformation into a non-planar configuration.

4. The flexible transponder of claim 1, further comprising a foundation,
wherein the flexible microelectronic circuit is mounted on the foundation, and
wherein the flexible antenna is printed on the foundation.

5. The flexible transponder of claim 1, wherein the flexible microelectronic circuit receives power through the flexible antenna by electromagnetic induction.

6. The flexible transponder of claim 1, wherein the flexible microelectronic circuit receives power through the flexible antenna by electromagnetic radiation.

7. The flexible transponder of claim 1, further comprising:
a multiplicity of flexible microelectronic circuits applied to a common layer.

8. The flexible transponder of claim 7, further comprising:
at least one flexible interconnect,
wherein the flexible interconnect couples one of the multiplicity of flexible microelectronic circuits to another of the multiplicity of flexible microelectronic circuits.

9. The flexible transponder of claim 8,
wherein the at least one flexible interconnect comprises a printable conductor.

10. The flexible transponder of claim 8,
wherein the at least one flexible interconnect comprises a conductor produced by a SOP process.

11. The flexible transponder of claim 1,
wherein the flexible microelectronic circuit is mounted to a first layer, and the flexible antenna is on a second layer, and the flexible antenna is coupled to the microelectronic circuit by lamination of the first layer to the second layer.

12. The flexible transponder of claim 1, further comprising a cover.

13. The flexible transponder of claim 12, wherein the cover is transparent.

14. The flexible transponder of claim 12, wherein the cover is an optical filter.

15. A flexible transponder comprising:
a flexible substrate;
a flexible microelectronic circuit constructed on the flexible substrate; and
a flexible transmission circuit coupled to the flexible microelectronic circuit,
wherein the flexible transmission circuit is congruent with or conformable to the flexible substrate.

16. The flexible transponder of claim 15, wherein the flexible transmission circuit operates using an optical transmission.

17. The flexible transponder of claim 15, wherein the flexible transmission operates using a magnetic field.

18. The flexible transponder of claim 1, further comprising:
a card body,
wherein the flexible hybrid system is attached to the card body to produce a smart card.
